(19) United States
(12) Patent Application Publication
(10) Pub. No.: US 2025/0283439 A1
(43) Pub. Date: Sep. 11, 2025

(54) METHOD OF OBTAINING A GRID OF BLADES OF AN AIRCRAFT THRUST REVERSING DEVICE

(71) Applicant: Airbus Operations SAS, TOULOUSE (FR)

(72) Inventors: Thierry GACHES, TOULOUSE (FR); Jérôme GAILLARDO, TOULOUSE (FR); Lionel SILLIERES, TOULOUSE (FR); Julie CAZALIS, TOULOUSE (FR); Stéphane ROULAUD, TOULOUSE (FR)

(21) Appl. No.: 19/071,268

(22) Filed: Mar. 5, 2025

(30) Foreign Application Priority Data
Mar. 7, 2024 (FR) FR2402299

(51) Int. Cl. F02K 1/72; B29C 70/34; B29L 31/08

(52) U.S. Cl. CPC F02K 1/72; B29C 70/342; B29L 2031/082; F05D 2220/323; F05D 2230/30; F05D 2240/129; F05D 2300/603

(57) ABSTRACT

A method of obtaining a grid of blades of an aircraft thrust reversing device by producing U-shape elements each including an integral central part corresponding to a blade and first and second branches each corresponding to at least a part of a longitudinal wall of the grid of blades and assembling which includes connecting the first branches of the various U-shape elements to one another in such a manner as to form a first longitudinal wall and connecting the second branches of the various U-shape elements to one another in such a manner as to form a second longitudinal wall.

### CROSS-REFERENCES TO RELATED APPLICATIONS

This application claims the benefit of French Patent Application Number FR2402299 filed on Mar. 7, 2024, the entire disclosure of which is incorporated herein by way of reference.

### FIELD OF THE INVENTION

The present invention relates to a method of obtaining a grid of blades of an aircraft thrust reversing device.

### BACKGROUND OF THE INVENTION

In an embodiment that can be seen in FIGS. 1 to 3, an aircraft 10 comprises a plurality of propulsion assemblies 12 positioned under the wings 14 of the aircraft 10 and connected to the latter by pylons 16. Each propulsion assembly 12 comprises an engine 18 positioned inside a nacelle 20. The engine 18 comprise a fan that has a rotation axis A18.

In the remainder of the description a longitudinal direction is parallel to the rotation axis A18. A longitudinal plane is a plane containing the rotation axis A18 and a transverse plane is a plane perpendicular to the rotation axis A18. The front/upstream and rear/downstream concepts refer to the direction of flow of a flow of air in the nacelle 20, flowing from the front (upstream) to the rear (downstream).

The nacelle 20 has an approximately tubular shape and with the engine 18 delimits an annular duct 22 in which flows a secondary flow of air. The nacelle 20 comprises an upstream section 24, called the air intake, a median section 26 in which the fan of the engine 18 is positioned, and a downstream section 28 that has a trailing edge 30.

The nacelle 20 comprises a thrust reversing device 34 positioned at the level of the downstream section 28 and configured to occupy an activated state in which it diverts at least some of the secondary flow of air circulating in the annular duct 22 outward and upstream of the nacelle 20 and an inactivated state in which it does not divert the secondary flow of air circulating in the annular duct 22.

The thrust reversing device 34 comprises at least one mobile part 36 that enables at least one lateral opening 38 (visible in FIG. 2) through the nacelle 20 to be formed.

The thrust reversing device 34 comprises a diversion system 40 configured to occupy a retracted position when the thrust reversing device 34 is in the inactivated state, in which the diversion system 40 does not interfere with the secondary flow of air, and a deployed position when the thrust reversing device 34 is in the activated state, in which the diversion system 40 interferes with the secondary flow of air and orients it toward the lateral opening 38.

The thrust reversing device 34 also comprises an orientation system 42 configured to orient the flow of air diverted by the diversion system 40. In accordance with one embodiment, the orientation system 42 comprises a plurality of grids of blades 44 called cascades positioned at the level of each lateral opening 38.

In accordance with an embodiment that can be seen in FIGS. 4 and 5 each grid of blades 44 includes longitudinal walls 46 positioned in approximately longitudinal planes and blades 48 positioned in approximately transverse planes. The longitudinal walls 46 and the blades 48 delimit cells 50.

The blades 48 have a profile for diverting upstream the flow of air exiting via each lateral opening 38. To this end, each blade 48 is curved and has a depth P, as depicted in FIG. 5.

In accordance with one arrangement the grid of blades 44 comprises five longitudinal walls 46 delimiting four rows of blades 48, sixteen blades 48 in each row and sixty-four cells 50.

Given their geometry and notably the small depth P of the blades 48, the grids of blades 44 include a large number of cells 50 and therefore have a relatively high mass, which for an aircraft represents a penalty in terms of onboard mass and energy consumption.

As depicted in FIGS. 6 and 7, a grid of blades 44 is generally made by molding a composite material, using for each cell 50 a core 52 configured to expand.

In accordance with one operating mode a method of obtaining a grid of blades 44 comprises a step of stacking layers of fibers to obtain first preforms 46′, one for each longitudinal wall 46, and second preforms 48′, one for each blade 48. As depicted in FIG. 6, the first preforms 46′ are substantially planar. The second preforms 48′ have an H-shape section provided at each end with first and second flanges 48.1′, 48.2′ that are intended to be pressed against first preforms 46′.

The method of obtaining a grid of blades 44 comprises, for each row of blades, a step of placing alternately second preforms 48′ and cores 52 between two substantially parallel (i.e., +/−10%) first preforms 46′, the first flanges 48.1′ of all the second preforms 48′ being pressed against the first preform 46′ situated on the left, the second flanges 48.2′ of all the second preforms 48′ being pressed against the first preform 46′ situated on the right. When all the first and second preforms 46′, 48′ have been positioned, the method comprises a consolidation or polymerization step to connect the first and second preforms 46′, 48′ together during which the assembly is compressed and subjected to an increase in temperature.

The rise in temperature causes expansion of the cores 52 which compress the second preforms 48′. After the consolidation or polymerization step the grid of blades 44 obtained and the cores 52 are cooled, which causes the cores 52 to shrink. The method then comprises a step of extraction from the mold during which the cores 52 are extracted from the grid of blades 44.

Given the relatively small depth P of the blades 48, the cores 52 compress them correctly during the consolidation or polymerization step, which enables control of the structural integrity of the grid of blades 44 obtained.

This method enables a good compromise to be achieved between providing pressure by expansion and preserving a capacity for extraction from the mold when the blades have a small depth. This method, suitable for blades with a small depth, is not suitable if the blades have a large depth, the cores not expanding sufficiently to compress the preforms. To enable extraction from the mold of a grid of blades that includes blades with a large depth, it is necessary to provide relatively complex sliding cores that are difficult or even impossible to extract.

More globally, because of their geometry, grids of blades are complex to produce.

### SUMMARY OF THE INVENTION

The present invention aims to remedy some or all of the disadvantages of the prior art.

To this end, the invention has for object a method of obtaining a grid of blades of an aircraft thrust reversing device, said grid of blades including at least first and second longitudinal walls oriented in a longitudinal direction and blades positioned between said first and second longitudinal walls, connected to the latter and oriented in a transverse direction.

According to the invention the method comprises:
a step of production of U-shape elements, one for each blade, each U-shape element including a central part corresponding to one of the blades, a first branch corresponding to at least a part of the first longitudinal wall and a second branch corresponding to at least a part of the second longitudinal wall, the central part and the first and second branches forming only one and the same part,
a step of assembling the U-shape preforms consisting in connecting the first branches of the various U-shape preforms to one another in such a manner as to form the first longitudinal wall and connecting the second branches of the various U-shape preforms to one another in such a manner as to form the second longitudinal wall.

Producing a grid of blades by assembling U-shape elements enables blades with large depths to be obtained whilst preserving simple tooling because of the geometry with no undercut of the U-shape elements.

In accordance with another feature, at least one U-shape preform has an interior face with no undercut. Additionally, the step of producing the U-shape preforms comprises, before the compression phase and for at least one U-shape preform, a draping phase during which layers of fibers are positioned on a first mold shaped like the interior face of the U-shape preform.

In accordance with another feature, each U-shape element is a U-shape preform made of a composite material, the production step including for at least one U-shape preform at least one compression phase and at least one curing or polymerization phase during which said U-shape preform is compressed and at least partially cured or polymerized.

In accordance with another feature, each U-shape preform is partially cured or polymerized during the production step, which comprises a phase of partial curing or polymerization, a phase of final curing or polymerization being carried out subsequently and at the latest during the assembly step.

In accordance with another feature, each U-shape preform is totally cured or polymerized during the production step.

In accordance with another feature, during the production step the U-shape preform is compressed between on the one hand the first mold and on the other hand at least one matching mold and/or at least one compression bladder.

In accordance with another feature, during the draping phase, the layers of fibers are positioned in such a manner as to have fibers mostly oriented in the transverse direction at the level of the central part and fibers mostly oriented in the longitudinal direction at the level of each of the first and second branches.

In accordance with another feature, during the draping phase at least one layer of fibers is positioned in such a manner as to extend over the central part and at least over one of the first and second branches.

In accordance with another feature, for each U-shape element the first and second branches are spaced by a distance apart that is substantially constant over their length. Additionally, the distances apart separating the first and second branches of the various U-shape elements decrease from one end to the other of the grid of blades so as to be able to form the first and second longitudinal walls by respectively stacking the first and second branches of the various U-shape elements.

In accordance with another feature, the first and second branches of the various U-shape elements have free ends situated at the level of one of the ends of the grid of blades.

In accordance with another feature, for at least one of the first and second U-shape elements each of the first and second branches comprises a first section that extends from the central part, a second section that extends from the first section as far as a free end of the first or second branch and an inclined section connecting the first and second sections. Additionally, the first sections of the first and second branches of the first and second U-shape elements are spaced by a first distance, the second sections of the first and second branches being spaced by a second distance greater than the first distance, the first sections of the first and second branches of the second U-shape element being positioned between the second sections of the first and second branches of the first U-shape element and connected to said second sections.

In accordance with another feature, for at least one U-shape element the central part comprises a first part forming a body of a blade and a second part substantially perpendicular to the first part forming a flange of the blade. In accordance with another feature, the second part extends over all the central part and at least partially along at least one of the first and second branches.

### BRIEF DESCRIPTION OF THE DRAWINGS

Other features and advantages emerge from the following description of the invention given by way of example only with reference to the appended drawings, in which:

FIG. 1 is a perspective view depicting one embodiment of an aircraft and a propulsion assembly,

FIG. 2 is a lateral view depicting a prior art embodiment of a propulsion assembly,

FIG. 3 is a schematic section depicting a prior art embodiment of a propulsion assembly equipped with a thrust reversing device in the inactivated step,

FIG. 4 is a perspective view depicting a prior art embodiment of a grid of blades,

FIG. 5 is a longitudinal section on the plane P-V of the grid of blades that can be seen in FIG. 4,

FIG. 6 is a schematic representation depicting a prior art embodiment of a step of placing longitudinal walls, blades and cores,

FIG. 7 is a view from above depicting a prior art embodiment of a grid of blades during a consolidation or polymerization step,

FIG. 8 is a perspective view depicting one embodiment of a grid of blades of the invention,

FIG. 9 is a longitudinal section on the plane P-IX of the grid of blades that can be seen in FIG. 8,

FIG. 10 is a perspective view depicting one embodiment of a blade of the invention,

FIG. 11 is a perspective view depicting one embodiment of a part of a grid of blades of the invention during assembly,

FIG. 12 is a cross section depicting one embodiment of a blade profiled member of the invention positioned on a mold,

FIG. 13 is a longitudinal section depicting one embodiment of a blade profiled member of the invention positioned between a mold and a matching mold,

FIG. 14 is a view from above depicting one embodiment of end plates of the invention,

FIG. 15 is a view from above depicting one embodiment of a part of a grid of blades of the invention during assembly,

FIG. 16 is a view from above depicting one embodiment of an assembled grid of blades of the invention,

FIG. 17 is a view from above depicting another embodiment of a part of a grid of blades of the invention during assembly.

### DETAILED DESCRIPTION OF THE PREFERRED EMBODIMENTS

In accordance with one application, an aircraft comprises at least one thrust reversing device including at least one grid of blades 60.

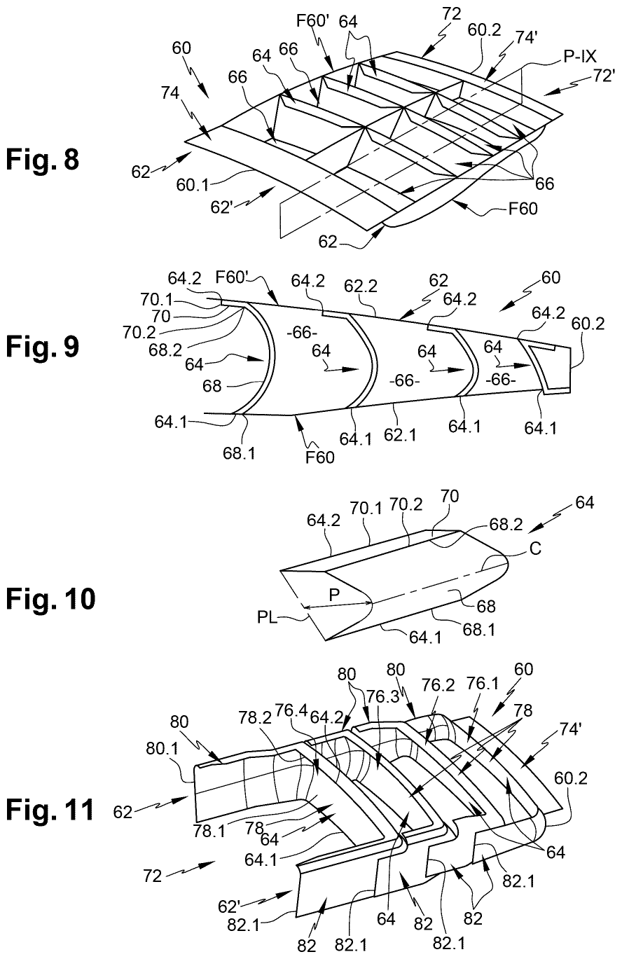

In accordance with an embodiment that can be seen in FIGS. 8 to 10, a grid of blades 60 includes at least first and second longitudinal walls 62, 62′ positioned in approximately longitudinal planes and blades 64 positioned between said first and second longitudinal walls 62, 62′, connected to the latter and positioned in approximately transverse planes, the longitudinal walls 62 and the blades 64 delimiting cells 66.

Each longitudinal wall 62 extends between inner and outer edges 62.1, 62.2. Each blade 64 extends between inner and outer edges 64.1, 64.2. In accordance with one arrangement, the inner edges 62.1, 64.1 of the longitudinal walls 62 and the blades 64 are positioned at the level of a first surface forming an interior surface F60 of the grid of blades 60, the exterior edges 62.2, 64.2 of the longitudinal walls 62 and the blades 64 being positioned at the level of a second surface forming an exterior surface F60′ of the grid of blades 60. In accordance with one configuration, the inner and outer surfaces F60, F60′ are curved to adapt to the curvature of the inner cell. Of course, the invention is not limited to this geometry of the outer and inner surfaces F60, F60′.

The blades 64 have inner and outer edges 64.1, 64.2 substantially parallel to one another and oriented in a transverse direction substantially perpendicular to the longitudinal direction.

In accordance with one configuration, each blade 64 has a substantially constant section in the transverse direction. The blades 64 can have identical sections. Alternatively, as depicted in FIG. 9, the blades 64 can have different sections from one blade to another.

In accordance with an embodiment that can be seen in FIG. 10, each blade 64 comprises a body 68 that extends between a first edge 68.1 corresponding to the inner edge 64.1 of the blade 64 and a second edge 68.2 and a flange 70 situated in line with the body 68 that extends between a first edge 70.1 corresponding to the outer edge 64.2 of the blade 64 and a second edge 70.2 rigidly attached to the second edge 68.2 of the body 68. In a longitudinal plane the flange 70 is substantially perpendicular to the body 68. For each blade 64 the body 68 and the flange 70 form one and the same part.

In accordance with one configuration, the flange 70 is substantially plane and situated at the level of the outer surface F60′ of the grid of blades 60.

The blade 64 has a depth P that corresponds to a maximum distance separating a plane PL passing through the inner and outer edges 64.1, 64.2 of the blade 64 and a generatrix C of the body 68 farthest from the plane PL.

In accordance with one configuration, the depth P of the blade 64 is relatively large. By relatively large is meant that the depth P does not allow extraction from the mold of the grid of blades using simple cores in accordance with a prior art method that can be seen in FIGS. 6 and 7.

In accordance with one arrangement, the grid of blades 60 comprises three longitudinal walls 62 defining two rows of blades 72, 72′ and four blades 64 per row of blades, the longitudinal walls 62 and the blades delimiting eight cells 66.

Given the depth P of the blades 64, it is possible to reduce their number, which tends to reduce the mass of the grid of blades 60.

Generally speaking, a grid of blades 60 comprises a plurality of rows of blades 72, 72′. However, a grid of blades 60 could comprise only one row of blades 72.

Whatever the embodiment, the grid of blades 60 comprises edge longitudinal walls corresponding to the farthest apart longitudinal walls 62. It extends between a front end 60.1 situated approximately in a first transverse plane and a rear end 60.2 situated approximately in a second transverse plane.

In accordance with one embodiment, the grid of blades 60 comprises at least one end plate 74, situated at the level of the front or rear end 60.1, 60.2, connecting the edge longitudinal walls and positioned at the level of the outer surface F60′ of the grid of blades 60. In accordance with a configuration that can be seen FIGS. 14 and 15, each end plate 74 is a substantially rectangular strip of material that has long sides substantially parallel to the transverse direction. At least one end plate 74 comprises at least one through-orifice 74.1 configured for fixing the grid of blades 60 to a structure of an aircraft.

In accordance with one arrangement, the grid of blades 60 comprises two end plates 74, 74′ positioned at the front and rear ends 60.1, 60.2 of the grid of blades 60.

In accordance with an operating mode that can be seen in FIGS. 11 to 17, a method of obtaining a grid of blades comprises:
a step of producing U-shape preforms 76.1 to 76.4 made of a composite material, one for each blade 64, each U-shape preform including a central part 78 corresponding to one of the blades 64, a first branch 80 corresponding to at least a part of a first longitudinal wall 62, and a second branch 82 corresponding to at least a part of a second longitudinal wall 62′, the central part 78 and the first and second branches 80, 82 forming only one and the same part,
a step of assembling the U-shape preforms 76.1 to 76.4 in such a manner as to obtain a row of blades by connecting the first branches 80 of the various U-shape preforms 76.1 to 76.4 to one another in order to form the first longitudinal wall 62 and connecting the second branches 82 of the various U-shape preforms 76.1 to 76.4 to one another in order to form the second longitudinal wall 62′.

When the grid of blades 60 comprises a plurality of rows of blades 72, 72′, the method of obtaining a grid of blades comprises a step of assembling the various rows of blades 72, 72′ in such a manner as to obtain the grid of blades 60.

When the grid of blades 60 comprises at least one end plate 74, 74′, the method of obtaining a grid of blades comprises a step of producing each end plate 74, 74′ and a step of assembling each end plate 74, 74′ consisting in connecting it to at least one U-shape preform 76.1 to 76.4.

Each U-shape preform 76.1 to 76.4 made of a composite material comprises fibers buried in a thermoset or thermoplastic resin matrix. Each end plate 74, 74′ is made of a composite material comprising fibers buried in a thermoset or thermoplastic resin matrix. In accordance with one configuration, the U-shape preforms 76.1 to 76.4 and the end plates 74, 74′ are made of the same composite material.

The steps of assembling the U-shape preforms 76.1 to 76.4, the rows 72, 72′ and the end plates 74, 74′ can be distinct steps. Alternatively, the steps of assembling the

U-shape preforms 76.1 to 76.4, the rows 72, 72′ and the end plates 74, 74′ can be carried out at the same time and constitute only one and the same step.

When the U-shape preforms 76.1 to 76.4 and the end plates 74, 74′ if any each comprise a thermoset resin matrix, each assembly step consists in connecting the U-shape preforms 76.1 to 76.4 and the end plates 74, 74′ if any with fixing elements such as rivets or screws for example, possibly using fishplates. Alternatively, the U-shape preforms 76.1 to 76.4 and the end plates 74, 74′ if any are connected by gluing or co-curing.

When the U-shape preforms 76.1 to 76.4 and the end plates 74, 74′ if any each comprise a thermoplastic resin matrix each assembly step consists in connecting the U-shape preforms 76.1 to 76.4 and the end plates 74, 74′ if any with fixing elements, such as rivets or screws for example, possibly using fishplates. Alternatively, the U-shape preforms 76.1 to 76.4 and the end plates 74, 74′ if any are connected by gluing, co-curing, co-consolidation or welding.

In accordance with a first operating mode, each U-shape preform 76.1 to 76.4 is partly cured or polymerized during the production step, which comprises a phase of partly polymerizing or curing, a phase of final polymerization or curing being carried out subsequently and at the latest during the assembly step.

In accordance with a second operating mode, each U-shape preform 76.1 to 76.4 is totally cured or polymerized during the production step that comprises a phase of complete polymerization or curing of the U-shape preform 76.1 to 76.4.

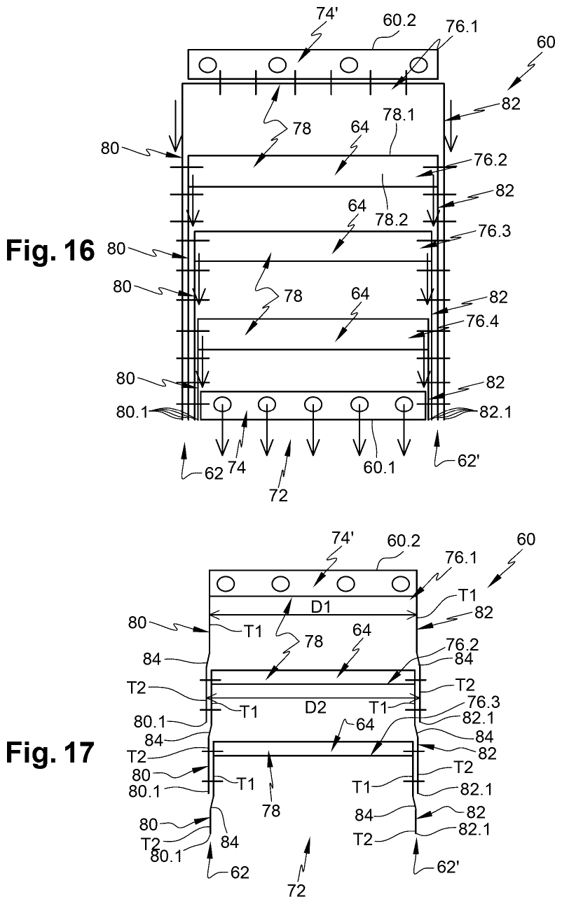

In accordance with a first embodiment that can be seen in FIGS. 15, 16, each of the first and second branches 80, 82 of each U-shape preform 76.1 to 76.4 is plane or curved. For each U-shape preform 76.1 to 76.4, the first and second branches 80, 82 are spaced by a substantially constant distance apart over their length. In accordance with this first embodiment, the distances apart separating the first and second branches 80, 82 of the various U-shape preforms 76.1 to 76.4 decrease from one end to the other of the grid of blades 60 so as to be able to form the first and second longitudinal walls 62, 62′ by respectively stacking the first and second branches 80, 82 of the various U-shape preforms 76.1 to 76.4. In accordance with one arrangement, the distances apart separating the first and second branches 80, 82 of the U-shape preforms 76.1 to 76.4 decrease from the rear end 60.2 to the front end 60.1 of the grid of blades 60. In accordance with this first embodiment, the distances apart separating the first and second branches 80, 82 of the various U-shape preforms 76.1 to 76.4 are determined so that for the first longitudinal wall 62 the first branches 80 are stacked against one another and connected to one another and so that for the second longitudinal wall 62′ the second branches 82 are stacked against one another and connected to one another.

In accordance with this first embodiment, the first and second branches 80, 82 of the various U-shape preforms 76.1 to 76.4 have two free ends 80.1, 82.1 situated at the level of one of the ends of the grid of blades 60, notably the front end 60.1 of the grid of blades 60. In accordance with this first embodiment, the grid of blades 60 comprises first, second, third and fourth U-shape preforms 76.1 to 76.4 offset in the longitudinal direction. The first preform 76.1 has a central part 78 situated at the level of the rear end 60.2 of the grid of blades 60 and first and second branches 80, 82 that extend from the rear end 60.2 to the front end 60.1 of the grid of blades 60. The first and second branches 80, 82 of the second, third and fourth U-shape preforms have free ends 80.1, 82.1 situated like those of the first and second branches 80, 82 of the first U-shape preform 76.1 at the level of the front end 60.1 of the grid of blades 60. Additionally, the end plate 74 situated at the level of the front end 60.1 has ends connected at least to the first and second branches 80, 82 of the fourth U-shape preform 76.4 having the central part 78 nearest the front end 60.1 of the grid of blades 60.

In a second embodiment that can be seen in FIGS. 11 and 17, for at least one of the first and second U-shape preforms 76.1 to 76.4 their first and second branches 80, 82 comprise a first section T1 that extends from the central part 78, a second section T2 that extends from the first section T1 to a free end 80.1, 82.1 of the first or second branch 80, 82, and an inclined section 84 connecting the first and second sections T1, T2.

In accordance with the second embodiment, the first sections T1 of the first and second branches 80, 82 are spaced by a first distance D1 and the second sections T2 of the first and second branches 80, 82 of the first and second U-shape preforms 76.1 to 76.4 are spaced by a second distance D2 greater than the first distance D1. All the U-shape preforms 76.1 to 76.4 have the same first distance D1 and the same second distance D2.

In accordance with a second embodiment, the first sections T1 of the first and second branches 80, 82 of the second U-shape preform are positioned between the second sections T2 of the first and second branches 80, 82 of the first U-shape preform and connected to those second sections T2.

Of course, the invention is not limited to these embodiments for connecting the U-shape preforms 76.1 to 76.4 to one another.

In an embodiment that can be seen in FIGS. 15 to 17, for at least one U-shape preform 76.1 to 76.4 the central part 78 comprises a first part 78.1 corresponding to the body 68 of the blade 64 and a second part 78.2 corresponding to the flange 70, substantially perpendicular to the first part 78.1 and extending only at the level of the central part 78 of the U-shape preform.

In accordance with another embodiment that can be seen in FIG. 11, for at least one U-shape preform 76.1 to 76.4 the second part 78.2 extends over all of the central part 78 and at least partially along at least one of the first and second branches 80, 82. In accordance with one arrangement, the flange 70 extends at the level of the central part 78 and over each of the first and second branches 80, 82, notably at the level of the first sections T1 of the first and second branches 80, 82. This embodiment enables better resistance to the forces produced on the flange 70 by a flow of air diverted by the grid of blades 60, those forces being transmitted to the body 68 and the first and second branches 80, 82.

At least one U-shape preform 76.1 to 76.4 has an interior face F76 including the interior surface F1 of the body 68 of the central part 78 oriented toward the first and second branches 80, 82, the interior surface F2 of the flange 70 oriented toward the first and second branches 80, 82, and the interior surfaces F3, F4 of the first and second branches 80, 82 oriented toward one another. In accordance with one particular feature of the invention, the interior face F76 of each U-shape preform 76.1 to 76.4 does not have an undercut shape in an extraction direction DT substantially parallel to the longitudinal direction.

In accordance with one embodiment, the step of producing the U-shape preforms 76.1 to 76.4 comprises for at least one U-shape preform 76.1 to 76.4 and preferably for all of them at least one phase of compression of said U-shape preform 76.1 to 76.4 and at least one curing or polymerization phase during which said U-shape preform 76.1 to 76.4 is compressed and at least partially cured or polymerized.

In accordance with one variant, the two phase of compression and curing or polymerization are simultaneous. In accordance with another variant, the curing or polymerization phase is completed before the end of the compression phase. In accordance with this variant, the U-shape preform 76.1 to 76.4 is compressed before the at least partial curing or polymerization is completed.

By way of example, during the compression and curing or polymerization phases each U-shape preform 76.1 to 76.4 is compressed at a pressure between 2 and 7 bar and heated to a temperature of the order of 180° C. Of course, the invention is not limited to these pressures and this temperature. The latter can vary as a function of the materials of a U-shape preform 76.1 to 76.4.

At the end of the production step, each U-shape preform 76.1 to 76.4 is sufficiently cured or polymerized to retain a stable geometry and stable dimensions.

These compression and at least partial curing or polymerization phases make it possible to guarantee the structural integrity of the grid of blades 60.

Before the compression phase, the step of production of the U-shape preforms 76.1 to 76.4 comprises for at least one U-shape preform 76.1 to 76.4 a draping phase during which layers of fibers 88 are positioned on a first mold 86.1 shaped like the interior face F76 of the U-shape preform 76.1 to 76.4.

Tooling 86 for carrying out the production step comprises for each U-shape preform 76.1 to 76.4 to be produced at least one first mold 86.1 on which the U-shape preform 76.1 to 76.4 is positioned at least during the compression and partial curing or polymerization phases.

Providing for each U-shape preform 76.1 to 76.4 an interior face F76 with no undercut makes it possible to use a simple first mold 86.1 and to be able to extract the U-shape preform 76.1 to 76.4 from the mold without difficulty.

In accordance with a first operating mode, during the production step the U-shape preform 76.1 to 76.4 positioned on the first mold 86.1 is compressed using at least one compression bladder. In this case, the tooling 86 comprises in addition to the first mold 86.1 at least one compression bladder.

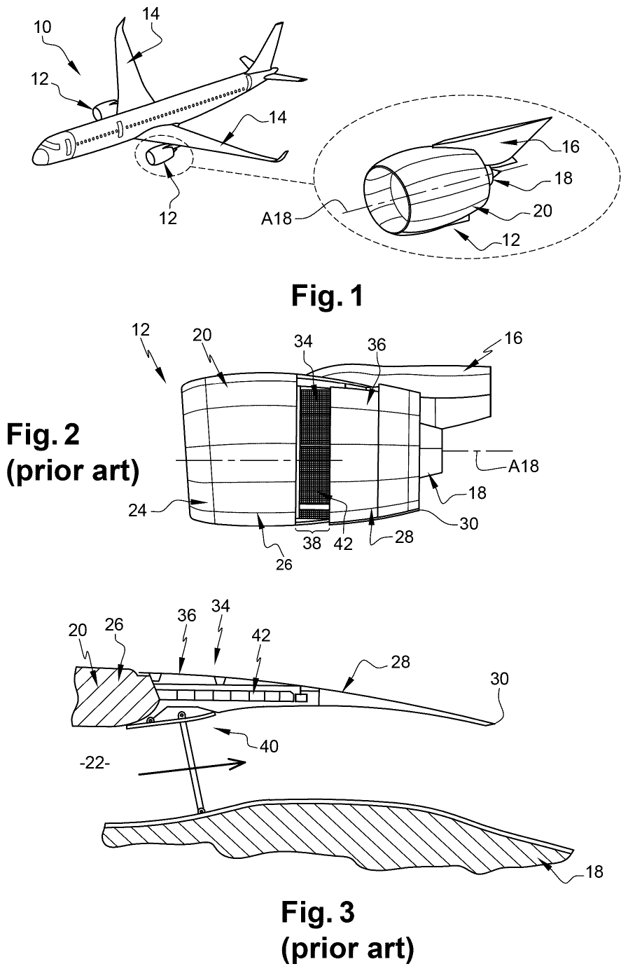

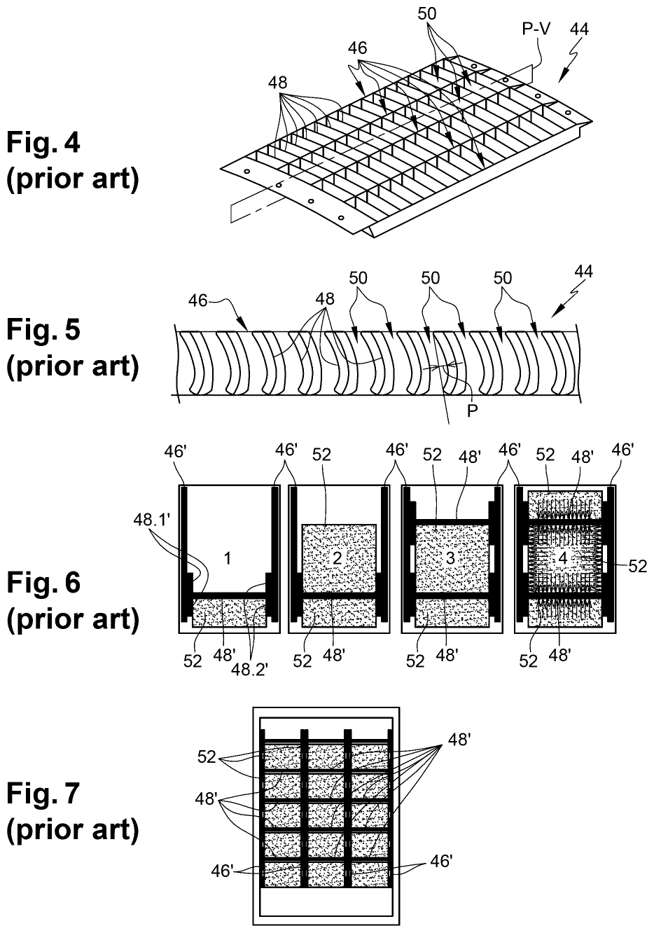

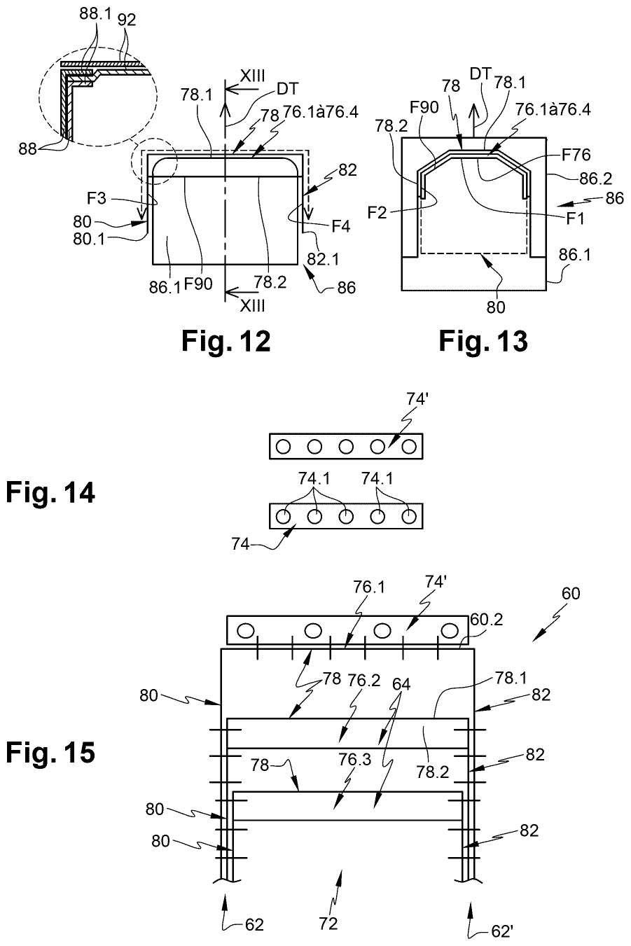

In accordance with a second operating mode that can be seen in FIGS. 12 and 1, during the production step the U-shape preform 76.1 to 76.2 is compressed between the first mold 86.1 and at least one matching mold 86.2. In this case the tooling 86 comprises in addition to the first mold 86.1 at least one matching mold 86.2.

In accordance with a third operating mode, during the production step the U-shape preform 76.1 to 76.2 is compressed between on the one hand the first mold 86.1 and on the other hand at least one matching mold and at least one compression bladder. In this case the tooling 86 comprises in addition to the first mold 86.1 at least one matching mold 86.2 and at least one compression bladder.

In accordance with one operating mode, the step of production of a U-shape preform 76.1 to 76.4 comprises a step of draping layers of fibers 88 on a placement mold having a placement surface F90 shaped like the interior face F76 of the U-shape preform 76.1 to 76.4. In accordance with one configuration, the placement mold on which the layers of fibers 88 are deposited corresponds to the first mold 86.1. Of course, the invention is not limited to this embodiment. The placement mold and the first mold 86.1 could be two distinct molds.

For at least one U-shape preform, during draping, at least one layer of fibers 88 is positioned so as to straddle the first and second parts 78.1, 78.2 of the central part 78 to obtain a body 68 and a flange 70 in one piece, which contributes to improved transmission of forces between these two parts of the blade 64.

For at least one U-shape preform, during the draping phase, the layers of fibers 88 are positioned in such a manner as to feature fibers mostly oriented in the transverse direction at the level of the central part 78 and fibers oriented mostly in the longitudinal direction at the level of each of the first and second branches 80, 82.

To ensure improved transmission of forces between the blade 64 and the longitudinal walls 62, 62′, the central part 78 is connected to each of the first and second branches 80, 82 with a relatively large radius of curvature so as to ensure improved transmission of forces from the central part 78 to the first and second branches 80, 82.

In accordance with one embodiment, for at least one U-shape preform 76.1 to 76.2, during the draping phase, at least one layer of fibers 88 is positioned in such a manner as to extend over the central part 78 and at least one of the first and second branches 80, 82. This embodiment makes it possible to improve the transmission of forces from the central part 78 to the first and second branches 80, 82. At least one layer of fibers 88 is preferably positioned in such a manner as to extend over the first and second parts 78.1, 78.2 of the central part 78 and at least one of the first and second branches 80, 82.

In accordance with one arrangement, as depicted in FIG. 12, at least one layer of fibers 88 of the first branch 80 has a part 88.1 positioned at the level of the central part 78. The central parts 88.1 of the layers of fibers 88 of the first branch 80 are stacked alternately with the layers of fibers 92 of the central part 78. At the level of the junctions between the central part 78 and the first branch 80 this arrangement can be duplicated at the level of the junction zone between the central part 78 and the second branch 82.

Of course, the invention is not limited to the embodiments that have been described. Thus the composite material U-shape preforms could be replaced by metal U-shape profiled members obtained by pressing.

Whatever the embodiment, a method obtaining a grid of blades 60 comprises:
a step of producing U-shape elements 76.1 to 76.4, one for each blade 64, each U-shape element 76.1 to 76.4 including a central part 78 corresponding to one of the blades 64, a first branch 80 corresponding to at least a part of the first longitudinal wall 62 and a second branch 82 corresponding to at least a part of the second longitudinal wall 62′, the central part 78 and the first and second branches 80, 82 forming only one and the same part,
a step of assembling the U-shape preforms 76.1 to 76.4 consisting in connecting the first branches 80 of the various U-shape preforms 76.1 to 76.4 to one another in such a manner as to form the first longitudinal wall 62 and connecting the second branches 82 of the various U-shape preforms 76.1 to 76.4 to one another in such a manner as to form the second longitudinal wall 62′.

When the grid of blades is made of a composite material, the U-shape elements correspond to U-shape preforms. When the grid of blades is made of metal, the U-shape elements correspond to U-shape profiled members.

Producing a grid of blades by assembling U-shape elements makes it possible to obtain blades with large depths while preserving simple tooling because of the geometry with no undercut of the U-shape elements.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A method of obtaining a grid of blades of an aircraft thrust reversing device, said grid of blades including at least first and second longitudinal walls oriented in a longitudinal direction and blades positioned between said first and second longitudinal walls, connected to the latter and oriented in a transverse direction, the method comprising the steps of:
producing U-shape elements, one for each blade, each U-shape element including a central part corresponding to one of the blades, a first branch corresponding to at least a part of the first longitudinal wall and a second branch corresponding to at least a part of the second longitudinal wall, the central part and the first and second branches forming only one and the same part, and,
assembling the U-shape preforms by connecting the first branches of the various U-shape preforms to one another in such a manner as to form the first longitudinal wall and connecting the second branches of the various U-shape preforms to one another in such a manner as to form the second longitudinal wall,
wherein at least one U-shape preform has an interior face with no undercut, and
wherein the step of producing U-shape preforms comprises, prior to a compression phase and for at least one U-shape preform, a draping phase during which layers of fibers are positioned on a first mold shaped like the interior face of the U-shape preform.

2. The method as claimed in claim 1, wherein each U-shape element is a U-shape preform made of a composite material,
wherein the step of producing includes for at least one U-shape preform at least one compression phase and at least one curing or polymerization phase during which said U-shape preform is compressed and at least partially cured or polymerized.

3. The method as claimed in claim 2, wherein each U-shape preform is partially cured or polymerized during the step of producing which comprises a phase of partial curing or polymerization, a phase of final curing or polymerization being carried out subsequently and no later than during the assembling step.

4. The method as claimed in claim 2, wherein each U-shape preform is totally cured or polymerized during the producing step.

5. The method as claimed in claim 1, wherein during the producing step the U-shape preform is compressed between the first mold and at least one matching mold, or at least one compression bladder, or both.

6. The method as claimed in claim 1, wherein during the draping phase, the layers of fibers are positioned in such a manner as to have fibers mostly oriented in the transverse direction at a level of the central part and fibers mostly oriented in the longitudinal direction at a level of each of the first and second branches.

7. The method as claimed in claim 1, wherein, during the draping phase, at least one layer of fibers is positioned in such a manner as to extend over the central part and at least over one of the first and second branches.

8. The method as claimed in claim 1, wherein for each U-shape element the first and second branches are spaced by a distance apart that is substantially constant over a length of the first and second branches, and
wherein the distances apart separating the first and second branches of the various U-shape elements decrease from one end to the other of the grid of blades so as to be able to form the first and second longitudinal walls by respectively stacking the first and second branches of the various U-shape elements.

9. The method as claimed in claim 8, wherein the first and second branches of the various U-shape elements have free ends situated at a level of one end of the grid of blades.

10. The method as claimed in claim 1, wherein for at least one of the first and second U-shape elements each of the first and second branches comprises a first section that extends from the central part, a second section that extends from the first section as far as a free end of the first or second branch, and an inclined section connecting the first and second sections,
wherein the first sections of the first and second branches of the first and second U-shape elements are spaced by a first distance, the second sections of the first and second branches being spaced by a second distance greater than the first distance, and
wherein the first sections of the first and second branches of the second U-shape element are positioned between the second sections of the first and second branches of the first U-shape element and connected to said second sections.

11. The method as claimed in claim 1, wherein for at least one U-shape element the central part comprises a first part forming a body of a blade and a second part substantially perpendicular to the first part forming a flange of the blade.

12. The method as claimed in claim 11, wherein the second part extends over all the central part and at least partially along at least one of the first and second branches.
